(19) United States
(12) Patent Application Publication
(10) Pub. No.: US 2011/0055003 A1
(43) Pub. Date: Mar. 3, 2011

(54) BUDGET-INFLUENCED RANKING AND PRICING IN SPONSORED SEARCH

(75) Inventors: Jinlin Wang, Mountain View, CA (US); Weiguo Liu, Dublin, CA (US)

(73) Assignee: Yahoo! Inc., Sunnyvale, CA (US)

(21) Appl. No.: 12/550,904

(22) Filed: Aug. 31, 2009

(51) Int. Cl. G06Q 30/00

(52) U.S. Cl. 705/14.45

(57) ABSTRACT

Methods and systems are provided for ranking of sponsored search advertisements, and for auction pricing, based on revenue factors in addition to bid amounts and click through rates including budgets associated with advertising accounts, campaigns and portions thereof. Methods are provided in which linear programming or other techniques are used to optimize the search engine revenue, and the optimized solutions are used in ranking sponsored search advertisements based on factors including an advertiser bid amount associated with the advertisement, a historical, estimated or predicted click through rate associated with the advertisement, and a budget over a period of time, such as a daily budget, the budget including spend associated with the advertisement. Instead of one fixed position, the new ranking is a service distribution on multiple positions.

### BACKGROUND

Sponsored search is enormously profitable business for marketplace providers such as search engines. In early forms, sponsored search marketplaces, such as those provided by search engines, included ranking and pricing of advertisements based solely on advertisers' bid amounts associated with the keywords in a sponsored search auction.

However, marketplace provider, or search engine, revenue was influenced not only by bid amounts, but also by click through rates associated with the served advertisements. Recognizing this, ranking and pricing methods arose in which not only bid amount, but also click through rates associated with advertisements, became utilized as factors influencing advertisement ranking and pricing in sponsored search. By bringing the focus more on, and substantially increasing, search engine revenue, this new approach to ranking and pricing led to a huge increase in search engine profit from the already hugely profitable business of sponsored search. In addition, it can be viewed that, by increasing user clicks on advertisements, this change of focus and methodology also led to a more efficient, and healthier sponsored search marketplace overall, for the search engine, the advertisers, and the users.

Bid amount and click through rate continue to be factors in current ranking and pricing methods, including some methods in which current pricing mechanisms are used and only ranking is changed.

There is a need for sponsored search advertisement ranking methods and systems or improved methods and systems.

### SUMMARY

Methods and systems are provided for ranking of sponsored search advertisements, and for auction pricing, based on revenue factors in addition to bid amounts and click through rates including budgets associated with advertising accounts, campaigns and portions thereof. Methods are provided in which linear programming or other techniques are used to optimize the search engine revenue, and the optimized solutions are used in ranking sponsored search advertisements based on factors including an advertiser bid amount associated with the advertisement, a historical, estimated or predicted click through rate associated with the advertisement, and a budget over a period of time, such as a daily budget, the budget including spend associated with the advertisement. Instead of one fixed position, the new ranking is a service distribution on multiple positions.

### BRIEF DESCRIPTION OF THE DRAWINGS

FIG. 1 is a distributed computer system according to one embodiment of the invention;

FIG. 2 is a flow diagram of a method according to one embodiment of the invention;

FIG. 3 is a flow diagram of a method according to one embodiment of the invention;

FIG. 4 is a conceptual block diagram illustrating one embodiment of the invention; and

FIG. 5 is a conceptual block diagram illustrating one embodiment of the invention.

While the invention is described with reference to the above drawings, the drawings are intended to be illustrative, and the invention contemplates other embodiments within the spirit of the invention.

### DETAILED DESCRIPTION

Some embodiments of the invention provide methods and systems for ranking sponsored search advertisements, and for auction pricing, based on factors including an advertiser-associated budget over a period of time. In some embodiments, methods and systems are provided for ranking of sponsored search advertisements based on factors including budgets associated with advertising campaigns or portions thereof. Methods are provided in which linear programming or other techniques are used in ranking sponsored search advertisements based on factors including an advertiser bid amount associated with the advertisement, a historical, estimated or predicted click through rate associated with the advertisement, an estimated inventory amount or number of clicks obtained at each position of search result pages for the next serving period, and a budget over a period of time, such as a daily budget, the budget including spend associated with the advertisement.

Herein, the term “ranking” includes the order in which items such as advertisements are positioned or presented with respect to one another. For example, ranking issues would include issues such as whether advertisement A is in position 1 and advertisement B is in position 2, or the reverse, where advertisement A is in position 2 and advertisement B is in position 1, etc. In particular for this invention the ranking may not be a fixed position, but rather a service distribution to multiple positions. The relative rankings are also not fixed to achieve the true maximization of search engine revenue.

An advertiser associated budget can include, for example, an advertiser specified maximum amount of spending over a specified period of time, or over a specified repeating period of time, such as a daily budget. Such a specified maximum amount of spending may be, for example, specified it a contract or agreement. In some instances, advertisers may use different budgets to explore or experiment with the effects of different maximum spending amounts, or for other reasons. The advertisers' specification may appear at various keyword group levels for example at account level and/or at a lower campaign level.

In some embodiments, marketplace provider or search engine revenue from sponsored search is greatly increased relative to previous ranking and pricing methods. For instance, previous ranking and pricing methods have used bid amounts and estimated or predicted click through rates. In some embodiments of the invention, advertiser budgets, associated with advertising campaigns or portions thereof, are taken into account in ranking and pricing. This can greatly increase search engine revenue as well as enhance marketplace efficiency generally.

For example, advertisement rank in a search result page may substantially influence the click through rate associated with advertisements. Furthermore, search engines advertising inventory, or most effective advertising inventory, as well as opportunities relating to such inventory, are limited. Still further, if ranking is determined without taking budget information into account, then budgets may be exhausted prior to the expiration of the time period associated with the budgets. This can lead to situations in which, although it may be more optimal to serve certain advertisements, they may not be able to be served, because an associated budget has been exhausted. This, in turn, lead to empty spots for advertisements, or less optimal advertisements needing to be served. However, if advertisements are ranked with budgets in mind, a more optimal situation can result.

For instance, tighter budgets may lead to lower ranked advertisements. Because of the tighter budget, a lower position may be enough to reach the budget limit. However, lowering the rank of the tighter budget advertisements can open up higher rank spots for advertisements with sufficient budget. Estimates or predictions relating to click through rates, serving opportunities, targeting opportunities, etc., along with bid amount information and budget information can allow much more optimized planning, scheduling, allocation and ranking of advertisements. Overall, this allows better use of all budgets, and leads to more revenue for the search engine. Of course, this is just a simplified explanation, but it demonstrates the point. Since sponsored search is an enormous source of revenue for search engines, and since this type of situation occurs very frequently, the associated increase in search engine revenue can be huge.

It should be noted that, in embodiments of the invention, information and factors influencing ranking and pricing are considered dynamically and globally, over many or all advertiser accounts, campaigns, budgets, serving opportunities, advertising inventory, etc. In some embodiments, global optimization of ranking and pricing including bid amount, click through, and budget information leads to optimized search engine provider revenue. Furthermore, as described herein, optimization, including ranking, can be considered over many serving events and over a period of time, and ca include, for example, assigning optimal percentages of presentation of particular advertisements at particular ranks based on factors including budgets, etc. As such, embodiments of the invention include optimization relating to ranking distributions over time and many events, etc. Linear programming or other techniques can be used in such optimization.

Furthermore, in various embodiments of the invention, optimization can be performed globally considering bid amount information, click through rate information, and budget information. Alternatively, such optimization can be performed in steps. For example an optimization step can be performed first without taking into account budget information, and then resulting parameters, such as rank and pricing, can be adjusted by factoring in budget and/or other revenue related information.

In some embodiments, auction pricing may be influenced by budgets, for example, in addition to ranking. For instance, advertisers may specify bid ranges, and methods according to embodiments of the invention may choose optimal specific bids. This can lead not only to optimized search engine revenue, but also to advantages to advertisers. It can also lead to a mechanism for leading to advertiser's choosing optimal budgets and bid amounts or ranges for the marketplace as a whole.

In some embodiments, pricing may be adjusted or otherwise determined based in part on factors including advertiser budgets. For example, in some embodiments, pricing for an advertiser with insufficient budget may be adjusted slightly upward to discourage or penalize lower budgets.

For instance, a tighter budget advertiser might bid lower, or have his bid amount adjusted to a lower end of the range, leading to lower rank and lower click through rate, since a greater number of serving opportunities relative to the budget may nonetheless lead to exhaustion of the budget and the same number of clicks as if the advertiser had bid higher. Conversely, a higher budget advertiser may more optimally bid higher, obtaining higher rank and click through rate, since serving opportunities may otherwise be insufficient to exhaust the advertiser's budget. A similar type of analysis applies to budget increases or decreases, in that a higher budget may encourage higher bids, etc. As a result, ranking and/or pricing based on information including budgets leads to more rational and efficient advertiser decision-making as well as more optimal allocation of advertiser resources. This in turn, leads to more search engine revenue and a more efficient marketplace.

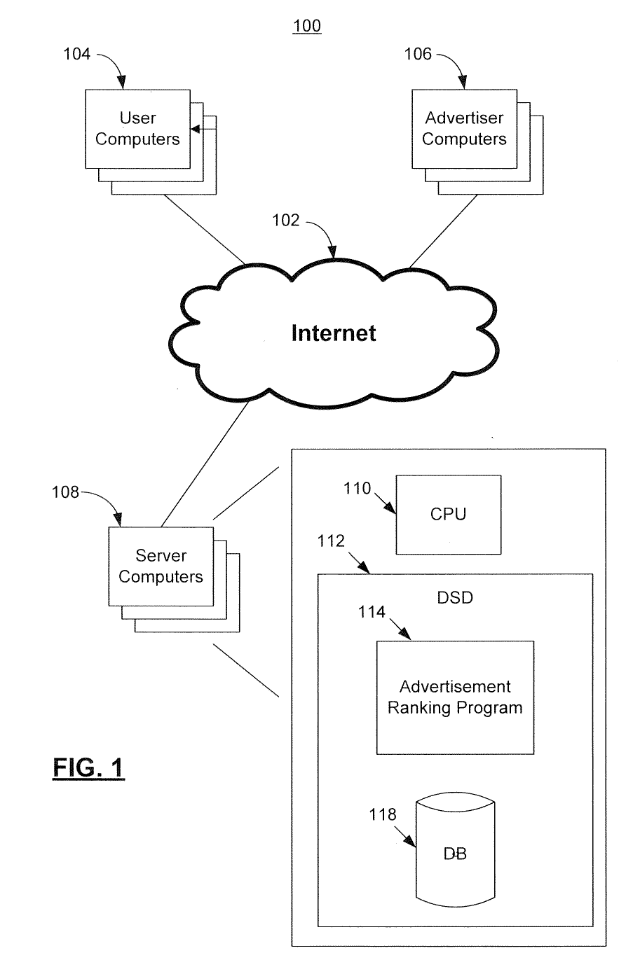

FIG. 1 is a distributed computer system 100 according to one embodiment of the invention. The system 100 includes user computers 104, advertiser computers 106 and server computers 108 connected or connectable to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, or other type of data storage devices, monitor, keyboard, pointing or selecting device, etc. The computers may operate using an operating system such as Unix/Linux or Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context. As depicted, each of the server computers 108 includes one or more CPUs 110 and a data storage device 112.

The data storage device 112 includes one or more databases 118, as well an advertisement ranking program 114.

The advertisement ranking program 114 is intended to broadly include programming, algorithms, applications, software, graphical user interfaces, models, and other tools or procedures necessary to implement or facilitate methods and systems according to embodiments of the invention, or computerized aspects thereof, whether on one computer or distributed among multiple computers or devices. These include local and global adjustment, decision making, or optimizations, ranking, pricing, allocation, scheduling, serving, and other techniques. In various embodiments, the elements of the advertisement management program 114 may exist on one computer, or may exist on multiple computers, devices, or locations.

In some embodiments, the server computers 108 may be part of an advertisement exchange. For example, some Web portals operate, utilize, or facilitate advertising exchanges. Such exchanges may virtually connect parties including advertisers, publishers, networks of advertisers, networks of publishers, and other entities. The exchange may facilitate arrangements, bidding, auctioning in connection with advertisements and advertisement campaigns, and may also facilitate planning and serving of advertisements. Advertisements that may be included within the exchange can include display or graphical advertisements that are not served in connection with user searches including keyword-based searches. The exchange may also include sponsored search advertisements, including advertisements served in association with user searches, such as keyword searches. Any type of simple or sophisticated advertisements may be included, such as text, graphic, picture, video and audio advertisements, streaming advertisements, interactive advertisements, rich media advertisements, etc.

In some embodiments, active advertisements are advertisements that are available for serving on or in connection with the exchange, whereas non-active advertisements are not so available. For example, non-active advertisements can include advertisements that are in review prior to be available for serving. This can include review as part of an editorial process to try to ensure or reduce the chance that inappropriate or dangerous advertisements are not allowed to be active.

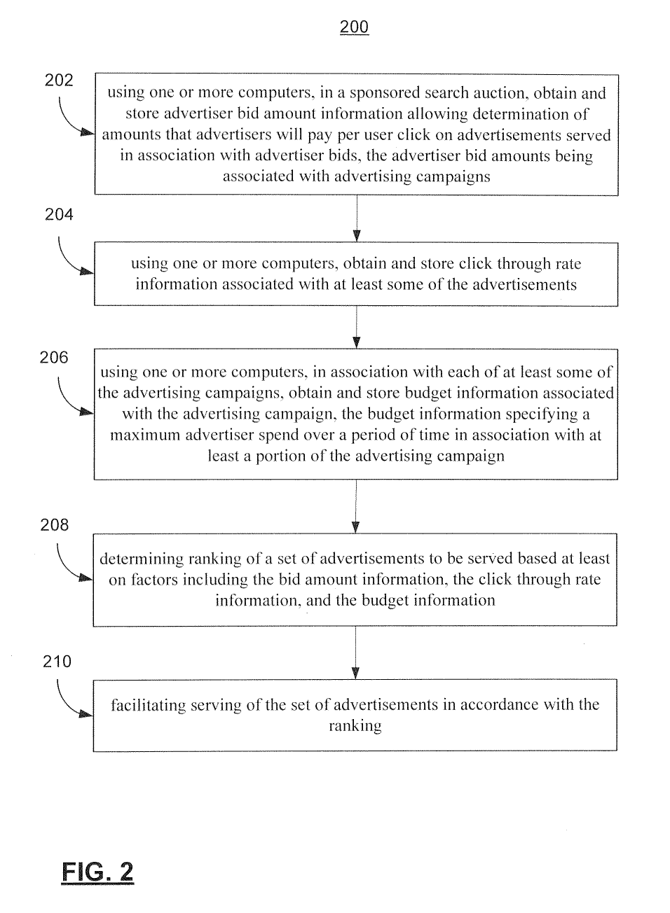

FIG. 2 is a flow diagram of a method 200 according to one embodiment of the invention. The method 200 can be facilitated or implemented using the advertisement ranking program 114. At step 202, using one or more computers, in a sponsored search auction, advertiser bid amount information is obtained and stored, the advertiser bid amount information allowing determination of amounts that advertisers will pay per user click on advertisements served in association with advertiser bids, the advertiser bid amounts being associated with advertising campaigns.

At step 204, using one or more computers, obtain and store click through rate information is obtained and stored, the bid information being associated with at least some of the advertisements.

At step 206, using one or more computers, in association with each of at least some of the advertising campaigns, obtain and store budget information is obtained and stored, the budget information being associated with the advertising campaign, and the budget information specifying a maximum advertiser spend over a period of time in association with at least a portion of the advertising campaign.

At step 208, ranking is determined of a set of advertisements to be served based at least on factors including the bid amount information, the click through rate information, and the budget information.

At step 210, serving of the set of advertisements in accordance with the ranking is facilitated.

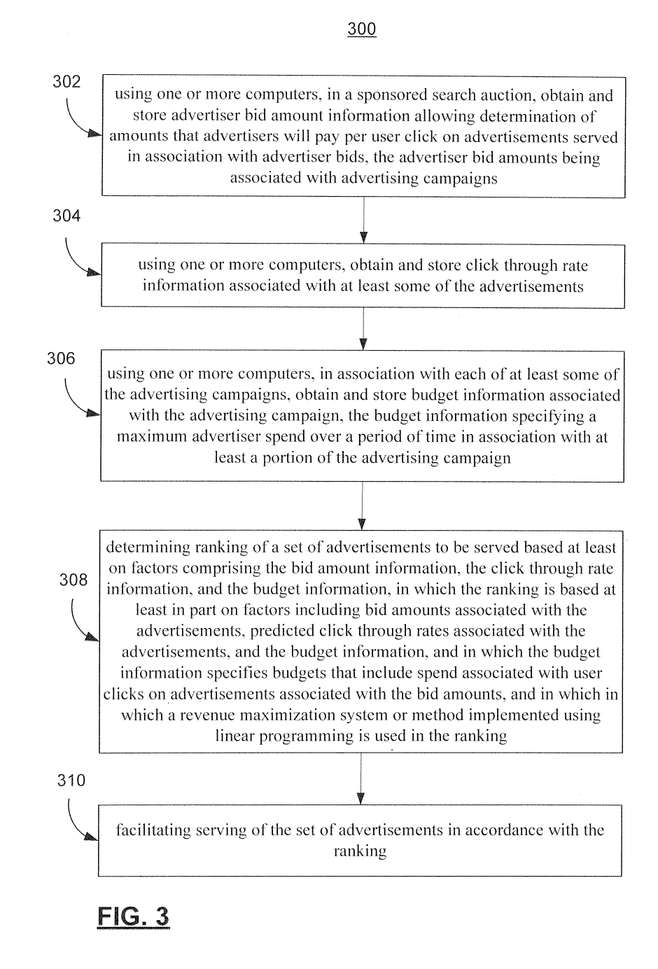

FIG. 3 is a flow diagram of a method 300 according to one embodiment of the invention. The method 300 can be facilitated or implemented using the advertisement ranking program 114.

Steps 302, 304 and 306 of the method 300 depicted in FIG. 3 are similar to steps 202, 204 and 206 of the method 200 depicted in FIG. 2.

At step 308, ranking is determined of a set of advertisements to be served based at least on factors including the bid amount information, the click through rate information, and the budget information. The ranking is based at least in part on factors including bid amounts associated with the advertisements, predicted click through rates associated with the advertisements, and the budget information. The budget information specifies budgets that include spend associated with user clicks on advertisements associated with the bid amounts. A revenue maximization system or method implemented as a linear programming is used in ranking.

Step 310 of the method 300 depicted in FIG. 3 is similar to step 210 of the method 200 depicted in FIG. 2.

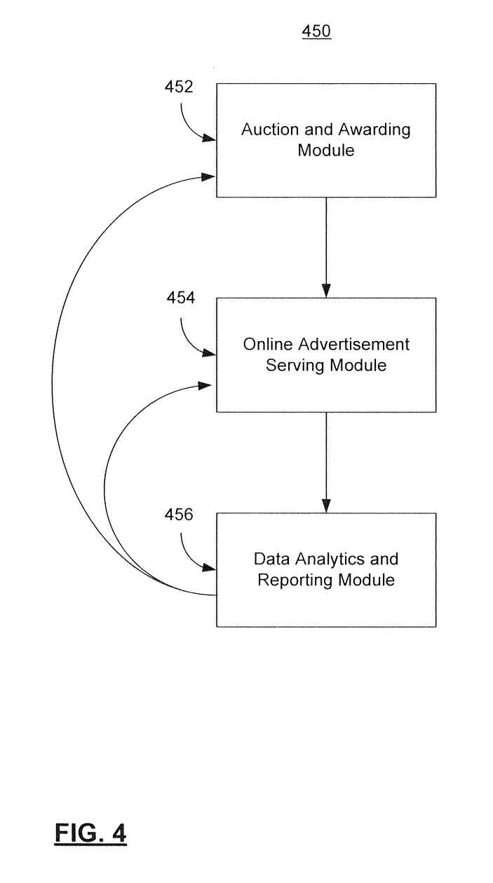

FIG. 4 is a conceptual block diagram 450 illustrating a system 450, such as a sponsored search system, which can include software, according one embodiment of the invention. The system 450 includes an auction and awarding module 452, an online advertisement serving module 454, and a data analytics and reporting module 456. Although conceptually depicted separately, it is to be understood that the functions of the modules 452, 454, 456 may not be entirely separate, may overlap, etc., and all of the modules 452, 454, 456 may be in communication with each other.

In some embodiments, the auction and awarding module 452 includes functionality in connection with operation and management of a sponsored search auction. The auction and awarding module 452 may include functionality including planning, including offline planning, decision-making or determination-making, advertiser communications in connection with the auction, obtaining bidding-related and offer data, allowing and facilitating bidding, determining pricing, etc. Generally, functionality of the auction and awarding module 452 includes functionality represented by the advertisement ranking program 114 as depicted in FIG. 1. In some embodiments, the online advertisement serving module 454 includes functionality in connection with serving of advertisements, which can include implementing planning performed by the auction and awarding module 452, actually serving advertisements, pages, etc. The online advertisement serving module 454 can also include obtaining, tracking, and communication of data in connection with the serving, associated activities, or user behavior associated with the serving, the served advertisements, etc. This can include communication of such data to the data analytics and reporting module 456.

In some embodiments, the data analytics and reporting module 456 includes functionality relating to analyzing, using, mining, and reporting based on data obtained or communicated by other modules, such as the auction and awarding module 452 and the online advertisement serving module 454. In some embodiments, the functionality can include forecasting, such as click through rate forecasting, and inventory estimation, such as estimating the number of clicks at each position for the next service period, etc. This data may be communicated to and used by, for example, the auction and awarding module 452. Furthermore, this can create a cyclic or repeating pattern, including repeated communications between the modules 452, 454, 456.

It is to be understood that, in some embodiments, the data analytics and reporting module 456, including its functionality and output, can be used for entirely different uses other than, or in addition to, those described above in connection with advertisement ranking, etc. For example, such functionality and data can be used in analysis, statistical analysis, user behavior or advertisement or campaign performance analysis, data mining, etc, and for any number of different purposes for which such data may be useful, provide insight, or be pertinent or minable to obtain pertinent information, such as by other systems.

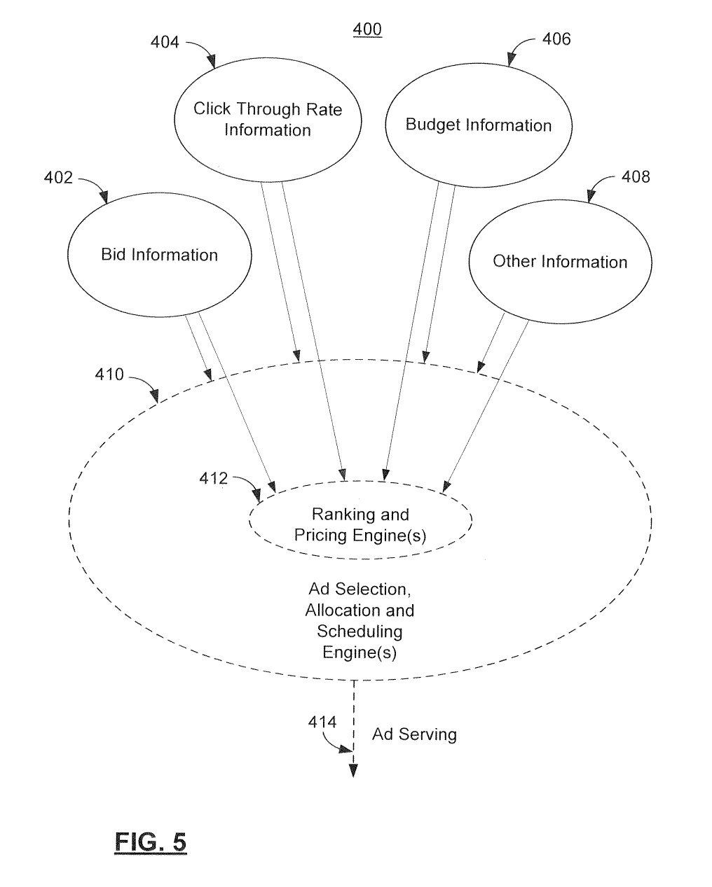

FIG. 5 is a conceptual block diagram 400 illustrating one embodiment of the invention. A ranking and pricing engine or engines 412 is depicted within an advertisement selection, allocation and scheduling engine or engines 410. Although depicted conceptually as within the advertisement selection, allocation and scheduling engine 410, it is to be understood that the ranking and pricing engine 412 may be separate, or partially or completely within, or overlap with, the advertisement selection, allocation and scheduling engine, in terms of programming, functionality, and implementation. Furthermore, it is to be understood that the advertisement selection, allocation and scheduling engine 410 is depicted merely conceptually. Its functions might overlap with other functions, might be distributed between or include other functions, etc.

In some embodiments, the functionality of the ranking and pricing engine 412 and of the advertisement selection, allocation and scheduling engine 410 may correspond to or partially correspond to the functionality of the auction and awarding module 452 as depicted in FIG. 4. Furthermore, ad serving 414 may correspond or partially correspond in functionality to the online advertisement serving module 454 as depicted in FIG. 4. Still further, the various data 402-408 can correspond or partially correspond to data provided by the data analytics and reporting module 456 as depicted in FIG. 4.

As depicted, information is obtained by the ranking and pricing engine 412 and the advertisement selection, allocation and scheduling engine, including bid information 402, click through rate information 404, budget information 406, and other information 408. The ranking and pricing engine 412 may use the bid information 402, click through rate information 404 and budget information 406 in determining auction pricing, such as reserve pricing, and in ranking of sponsored search advertisements.

The following includes a description of a context of some embodiments of the invention as well as details and simplified examples relating to some embodiments of the invention. It is to be understood that the description is for illustrative purposes only, and is non-limiting.

Web search engines have become major gateways for web information retrieval. Sponsored search is now a multi-billion dollar business. The sponsored search bidding process, ranking and auction pricing have been evolved continuously. Eventually, pricing schemes based on a single factor, bid amount, have previously evolved to be replaced by schemes based on two factors, bid amount and click through rate (CTR). The reason for this is clear, since revenue for a marketplace provider such as a search engine may be determined using bid amount multiplied by the number of clicks.

With the per click price for a keyword getting higher, advertisers are more careful in managing their campaigns. One way often used is to limit the budgets over a period of time, such as daily budgets, on accounts or campaigns, and shift the budget between campaigns or portions thereof, to better fit to the market changes. For many major search engines, the daily maximum spending, or the budget, can be specified at account, campaign or even at the keyword group levels. When the daily budgets for campaigns are tight, the utilization of the search results pages (SERP) and the total revenue for a search engine is very much tied with a budget-based factor. The following simplified example illustrates how budgets influence total revenue for a marketplace provider such as a search engine.

In the following simplified example, no particular pricing schema is used, and it is assumed that the search engine can earn a fixed price (cost per click, or CPC) from each click of an advertisement (ad), whether the CPC is user specified or an estimated average value. Suppose there are three bidders A, B and C for a given phrase. The bidding data is given in the following table.

TABLE 1

| Bidder | Cost per click ($) | Daily Budget ($) |
|---|---|---|
| A | 1.00 | 100.00 |
| B | 0.50 | 50.00 |
| C | 0.40 | 500.00 |

The advertisements from the three bidders are assigned to a results page. Suppose from the history data, the average total numbers of daily clicks are obtained at various positions as in the table below.

TABLE 2

| Position | Average daily clicks |
|---|---|
| 1 | 200 |
| 2 | 140 |
| 3 | 60 |

These hypothetical numbers of clicks are the results for an average advertiser. For purposes of this example, it is simply assumed that same click through rate applies for all three bidders, i.e. they are all “average”. In that case, the default ranking is the bid amount for the circumstances, i.e. the ranking is fixed as 1, 2, 3 for A, B and C. A naive way to serve the ads is to show ads in this order until either the budget is exhausted or day cods. Following this service plan, the delivery for a typical day can be shown in the following table.

TABLE 3

Time
Share

| | 0.5 | | 0.15 | | 0.35 | |
|---|---|---|---|---|---|---|
| | (12 hours) | | (3.6 hours) | | (8.4 hours) | |
| Position | clicks | | Clicks | | clicks | |
| 1 | A | 100 | B | 30 | C | 70 |
| 2 | B | 70 | C | 21 | | |
| 3 | C | 30 | | | | |

Both A and B reached their maximum budget for the day and C gets 121 clicks for a revenue of $48.4. The total revenue from the page is $198.4.

However, if one does a little more planning, it is easy to see that A and B have tight budget. Even if one keeps the ranking order A, B and C, one can serve A and B alternatively at position 1 and keep C at position 2 until both A and B maxed out, as shown below.

TABLE 4

Time Share

| | 0.5 | | 0.5 | |
|---|---|---|---|---|
| Position | clicks | | Clicks | |
| 1 | A | 100 | B | 100 |
| 2 | C | 70 | C | 70 |

With this plan, C gets 140 clicks or $56 and total revenue is $206.0.

Going still further by way of optimization, if one is given the freedom to serve ads in any order to earn the most revenue, then a more optimized way of serving is to put C at position 1 and alternatively serving A and B at position 2 and 3, as shown below.

TABLE 5

Time Share

| | 0.5 | | 0.5 | |
|---|---|---|---|---|
| Position | clicks | | Clicks | |
| 1 | C | 100 | C | 100 |
| 2 | A | 70 | B | 70 |
| 3 | B | 30 | A | 30 |

Then C gets 200 clicks or $80. The total revenue is $230.

From this highly simplified example, one can nonetheless see that ignoring the daily budget may potentially cause a high revenue loss. Even under typical current ranking and pricing schema, a planned service schedule may help a search engine save some money. If one allows the correct or optimized ranking based on a third factor, specifically, a budget, such as a daily budget, the inventory of the search engine results pages can be better utilized and the revenue saving can be very significant. Not only that, but it can be viewed that more optimized ranking brings a healthier marketplace overall.

The following provides a more detailed review of typical contexts and non-limiting explanations of some embodiments of the invention.

Typically, when a user types in a search query, the search engine returns a search engine results page (SERI)). In the results page, there are two main lists. One is organic or algorithmic list. The other is the sponsored or paid search list. The sponsored list can be empty for many queries.

Typically, a part or portion of SERP spaces are sold for sponsored listings or advertisements using auction method. Advertisers enter bids for search queries and set up the text contents for the link. A bid typically consists of the following information. First of all, the bid phrase and the match type, which tells the search engine the targeted search queries. When the match type is not “exact”, the search engine may match the bid with search phrases that are considered relevant but not exactly same as the bid phrase. The bid may need to specify the maximum cost the advertiser is willing to pay for each click, or the max CPC. The bid may also need to specify the creative, or the advertisement that shows on the SERP.

Bid phrases can be organized in a various levels of grouping. These include ad group, campaign, and account, among potentially many others. Ad groups may be user defined or related groups of advertisements within a campaign, and the campaign may be one of several associated with an account of a particular advertiser. The bid may specify the maximum spending or budgets, such as daily budgets, at various grouping level. For example, when the total cost reaches the budget, the ads within the specified level may not shown for the rest of the period or day, to avoid additional spending.

When bids are entered, the search engine ranks the bids to determine who wins which position and starts to facilitate serving or to serve or to map search queries to sponsored lists. When a sponsored link is clicked, the bidder pays the search engine a certain amount that is determined by the auction rules.

Although bids can be entered or changed any time of the day, the search engine needs time to organize bids and push the new data into the search server. The length of the latency period depends on the search engine and may be a few hours. It can be regarded, assumed or estimated, such as for explanation purposes, or even actually implemented that for a short service period, one or a few hours, the bids are kept same.

Most of search engines allow various types of user targeting. For example, this may include showing ads only to users in certain locations, which may be included within or known as geographic targeting or geotargeting, or showing ads only at certain time of the day, which may be included within or known as day parting. Such targeting conditions are also entered or included as part of the bids and often cost structures may vary for these additional conditions.

In some embodiments of the invention, marketplace provider revenue is estimated or predicted and maximized for a given future period. Furthermore, in some embodiments, a linear programming technique or an algorithm utilizing linear programming, is used for this and for associated planning. In some embodiments, other types of techniques and algorithms may be used, which may include data mining, machine learning and optimization techniques.

In some embodiments, a linear programming formulation is used to find an optimal service plan for the next service period. Herein, the term optimize broadly includes techniques or methods that are better relative to others or best or near best among all feasible solutions. Other forms of the word “optimize” have similar broad meanings herein.

In some embodiments, the estimate uses cost per click (CPC) values to find out the maximum revenue a search engine can earn under the current bid conditions. The CPC value can be the bid amount (max CPC), and the objective may be a theoretic maximum revenue. One can also use an average CPC, in which case the results may be closer to the service practice. In one embodiment, the CPC from generalized second price auction is used and the optimization results are used for ranking purpose only. One may also estimate a number of clicks for each position on each result page.

In some embodiments, the bidders are allowed to specify daily maximum spending at some grouping levels. For example, to represent this relationship in a network, let a node represent an account, a campaign, a group and a bid. Graphically the structure is a simple tree. The formulation in this part of the network may be straight forward, but tedious. In the following formulation, for simplicity, an illustration is provided with one organization level, specifically the campaign level. This simplification allows focus on the revenue optimization problem.

Let C be the set of campaigns and B be the set of all bids. Every bid bεB belongs to a campaign cεC. Let B(c) be the set of bids that belong to campaign c. For every campaign c, the bidder specifies a maximum daily spending amount, denoted by budget(c). For each bid b, the bidder specifies a maximum price to pay for each click on the ad, denoted by bid(b). The actual price paid for a click is often less than the bid amount. The formulation allows various pricing schema to be used. In general, cpc(b) is used to be the price in the formulation.

A bid can be assigned to some positions in a search engine results page (SERP). In the network representation a bid is eligible for every position of the page. Since web pages are dynamic, in practice, a bid often appears at different positions for different searches or views. When the match type for the bid is not exact, a bid may also be assigned to multiple result pages. Let P be the entire set of all SERP sponsored positions. The relationship between the bids and the positions can be viewed as a huge bipartite graph. A b-p arc exist if and only if the bid b can be assigned to the position p. The relationship is denoted by (b, p)εA. For each position p, the search engine estimates how many clicks the position is going to attract for the next service period. This number is an average and advertiser neutral estimation, i.e. the number of clicks an average advertiser attracts at the position, and is denoted by clicks(p). Because of many factors, advertisers have different click through rates. The difference can be captured in a click score q(b, p), sometime called clickability. The expected number of the clicks the bid b can get at position p

is q(b, p)*clicks(p). For example, the bid b with q(b, p)=1.0 has average click through rate. A bid b′ with q(b′, p)=2.0 can attract twice as many clicks in the same position p. Hence, the ratio between the bids shows the difference of the click through rates. Often, at one result page, the quality scores for one bid change very little for various positions. Some search engines incorporate other quality scores into the q(b, p), for our purpose, the click through rate is the only factor. The expected value of assigning bid b to position p
is ν(b, p)=cpc(b)q(b, p). When using max CPC, the value ν(b, p)=bid (b)q(b, p) is called the expected bid value.

In the following linear programming formulation, there are capacity and budget constraints. There are assignment constraints to link the supply and demand sides. The objective is to maximize the total revenue. There are two sets of the decision variables. Let x(c,b) be the dollar amount of campaign c that is assigned to bid b. Let y(b,p) be the shares of serving period when bid b is assigned to position p. This leads to 0≦y(b,p)≦1. This is denoted in the formulation given by LP1.

The objective is to maximize the total revenue from all campaigns,

Max(Σ(cεC)(Σ(bεB(c)))). (LP1-1)

The revenue from a campaign is limited by the campaign budget,

Σ(bεB(c))x(c,b)≦budget(c),∀cεC (LP1-2)

The revenue from a bid is the total from all its positions,

x(c,b)−Σ{p:(b,p)εA}ν(b,p)clicks(p)y(b,p)=0,∀bεB. (LP1-3)

The shares of clicks at a position sum up to at most one,

Σ{p:(b,p)εA}y(b,p)≦1,∀pεP. (LP1-4)

The shares of clicks at a bid sum up to at most one,

Σ{p:(b,p)εA}y(b,p)≦1,∀bεB. (LP1-5)

Nonnegative for both x and y,

x(c,b)≧0,y(b,p) (LP1-6)

Let ψ(c), ψ(b), π(b), π(p) be the dual variables corresponding to constraints (LP1-2), (LP1-3), (LP1-4) and (LP1-5) respectively. The dual formulation is given in the following.

min(Σ(c)ψ(c)+Σ(b)π(b)+Σ(p)π(p))

The campaign-bid constraints,

ψ(c)+φ(b)≧1,∀(c,b),bεB(c),

The bid-position constraints,

π(b)+π(p)ν(b,p)clicks(p)φ(b)≧0,∀(b,p)εA,

Nonnegative constraints,

ψ(c)≧0,π(b)≧0,π(p)≧0,

Herein, definitions, proofs, etc. are merely illustrative, examples, or for examples, and are non-limiting.

Definition 2-1. A bid b is assigned to position p in a solution (x,y) of LP1, if y(b,p)≧0.

Definition 2-2. A campaign c is budget sufficient for a solution (x,y) of LP1, if the inequality of (LP1-2) is hold true for the solution, i.e. ΣbεB(c)x(c,b)<budget(c).

Definition 2-4. A bid is fully serviced by a solution (x,y) of LP1, if the equality holds for (LP1-5). A position is fully serviced by a solution (x,y) of LP1, if the equality holds for (LP1-4).

A position is fully serviced if there is a bid serviced at the position for every search or view of the page.

For two positions on different result pages, they are not comparable. For two positions p and p′ on the same result page, denoted p>p′, if position p is lower than position p′. For one results page, the average numbers of clicks clicks(p) decrease significantly when positions lower. For one advertiser b, the click adjust factor q(b, p) for different positions on the same page is either a constant or only vary a small amount. Therefore for one advertiser the values ν(b, p)clicks(p) decreases significantly as the position on the page lower.

The current ranking and pricing method does not take budget into consideration. This is equivalent to assume that every campaign is budget sufficient. Let us find out the ranking suggested by the linear programming under this assumption.

Lemma 2-3. If a campaign c is budget sufficient for an optimal solution (x,y) and a bid bεB(c) is assigned to position p, then either b is fully serviced or p is fully service.

Proof. If not, then a new feasible solution can be constructed. A small amount is added to y(b,p) and a corresponding amount is added to x(c,b). When the amount is small enough the new solution is feasible however the objective value is higher than that of (x,y) that contradicts the optimality.

Theorem 2-4. If all campaigns are budget sufficient for an optimal solution (x,y) and p and p′ are two positions on the same page where p<p′, then for any bid b assigned to p and b′ assigned to p′, leading to ν(b, p)≧ν(b′, p′).

Proof. The argument is similar to the proof of Lemma 2-3. If ν(b, p)<ν(b′, p′), one has a delta adjustment along the augmenting circle (b,p,b′,p′,b), i.e. y(b,p) is decreased, y(b′,p′) is decreased by amount δ, and y(b,p′) and y(b′,p) are increased by the same amount. To balance LP1-3, the increase on x(c′,b′) is δ(ν(b′, p)clicks(p)−ν(b′, p′)clicks(p′)) and the decrease on x(c,b) is δ(ν(b, p)clicks(p)−ν(b, p′)clicks(p′)). Because at the same page, ν(b, p)≅ν(b, p′) and ν(b, p)<ν(b′, p′), there is a net increase on the objective value that contradicts to the optimality of (x,y).

This theorem tells one that when budgets are all sufficient, the optimal ranking is by the expected value v(b,p). The higher the v(b,p) the higher the rank at one page.

In the following, the generalized second price auction is described, and embodiments of the invention are illustrated in association therewith.

In a second-price sealed-bid auction, the winning bidder pays the highest bid amount of non-winners. The idea has been applied to sponsored search. The eligible bidders for one search are b(1), b(2), . . . , b(k) and their bids are bid(b(i)), i=1, . . . , k. The initial application of some search engines was to rank the bidders by the descending order of the bid amount. If the ith bidder's advertisement is clicked then she pays the bid price of the (i+1)th bidder. In this mechanism, the ranking and pricing based on one factor, the bid price. Herein, this implementation is called a 1-factor second price auction.

However the seller's revenue may be the product of the price and the number of clicks. In other words, for each result page delivery, the other half of the revenue is the probability of an ad being clicked. This probability, called the click through rate (CTR), depends on the advertiser and the text, or creative, of the advertisement. Another generalization of the second price auction came to be utilized, herein called a 2-factor second price auction. In some implementations, the ranking depends on the product of two factors, the bid and the click through rate, equivalent to the expected bid value

ν(b, p)=bid (b)q(b, p). If the ith position in a page is denoted pᵢ and the ith ranked bidder is b(i). One has ν((b(i)p(i))>ν((b(j),p(j)), ∀i<j. The price for bidder on the ith ranking is determined by the following:

cpc(b(i))=bid(b(i+1))q(b(i+1),p(i+1))/q(b(i),p(i+1)) (3-1)

and the lowest ranked bidder pays the reserve price.

Note some search engines assign reserve prices for every bidder-page pairs and if the bid amount is less than the reserve price then the bid is regarded as ineligible for the page. Herein only eligible bids are discussed, although embodiments of the invention are not so limited. As discussed previously, the ranking determined by the 2-factor second price coincides with the optimization ranking under the condition that every campaign is budget sufficient.

A difficulty in incorporating the third major factor, the budget, into the second price auction is that the measure of budget tightness cannot be made locally on one page. One has to consider all campaigns and all accounts to know if the budget for one campaign is actually tight. One way to localize the problem is to use past service experience to determine a throttling rate for each campaign. For example, if a campaign has a throttling rate of 0.7 then it only needs to be served 30% of times. However, this is not ideal because it may leave many empty positions during the serve. As such, a localized adjustment in a two-factor marketplace is not ideal. A better or true optimal solution must include better ordering and utilization of an SERPs.

From the foregoing, it is a shown that, when budgets are not considered, an optimization solution returns the same ranking as in the generalized second price auction.

In some embodiments of the invention, an optimization is used that further considers the budget limitations and returns a solution that best utilizes the spaces in the result page. In Example 1, it has been shown that the rank change is inevitable when one wants to better utilize the SERP spaces. Some embodiments of the invention use the prices determined by the 2-factor second price auction in formulation (3-1). Following this, an optimization algorithm or inventory optimization algorithm may be used to determine the final ranking under the given prices. Some embodiments of the invention include the following steps:

Step 1, Rank and price all bids as in 2-factor second price auction.

Step 2, Run optimization with the prices calculated by (3-1).

Step 3, Use the optimization solution to guide the service.

In the following example, according to one embodiment of the invention, prices are used from the GSP auction. Let bid and the daily budget are same as in example 1. Click score and cost per click are added from the auction rule. The bidding data and the auction determined CPC data is given in the following table. The SERP data is still used as from previous example data, in that in average the number of clicks from position 1, 2 and 3 are 200, 140 and 60 respectively. It is assumed that the reserved price for the page is $0.40, i.e. the minimum payment for each click is 40 cents.

TABLE 6

| | | Click | Revenue | | |
|---|---|---|---|---|---|
| | Bid | Score | rate | | Daily |
| Bidder | ($) | q(b, p) | v(b, p) | CPC($) | Budget($) |
| A | 1.00 | 1.0 | 1.0 | 0.66 | 100.00 |
| B | 0.50 | 1.3 | 0.65 | 0.47 | 50.00 |
| C | 0.40 | 1.5 | 0.6 | 0.40 | 500.00 |

A direct service using the 2-factor second price auction serves in order (A,B,C) until budget exhaust. The advertiser A′s budget exhausts when receives 100/0.66=151.52 clicks, budget for B exhausts when B receives 50/0.47=106.38 clicks. Note that B has click score of 1.3, so it can get 140*1.3 clicks if assigned to position 2. Similarly for C, it gets 1.5 times clicks per time unit. Since the solution always reaches maximum bud for A and B, it is only needed to count number of clicks on C and the revenues from it. The SERP service table is the following.

TABLE 7

Time Share

| | 0.5845 | | 0.1731 | | 0.2424 | |
|---|---|---|---|---|---|---|
| Position | Clicks | | Clicks | | Clicks | |
| 1 | A | 116.90 | A | 34.62 | C | 72.72 |
| 2 | B | 106.38 | C | 36.35 | | |
| 3 | C | 52.61 | | | | |

The total clicks for C 161.68 and total revenue for C is $64.67. The total revenue for all three is $214.67. An obvious problem is that the page is not ell utilized. The position 2 and 3 are not fully served.

A more optimal solution uses the same price for each bidder. It fully serves all three positions during the service period and therefore better utilizes the page.

TABLE 8

Time spend

| | 0.5558 | | 0.2729 | | 0.1713 | |
|---|---|---|---|---|---|---|
| Position | Clicks | | Clicks | | Clicks | |
| 1 | A | 111.16 | C | 81.87 | C | 51.39 |
| 2 | C | 116.72 | B | 49.67 | A | 23.98 |
| 3 | B | 43.35 | A | 16.37 | B | 13.36 |

Total clicks for C=249.98 and total revenue from C is 99.99. The total revenue for all three is $249.99.

In the following example, effects of one bidder's change on budget or bid amount are considered. If B added 20% or $10 to its budget, then all the money added works on gaining more clicks for B. An optimal solution is shown in Table 9.

TABLE 9

Time Share

| | 0.5225 | | 0.3463 | | 0.1312 | |
|---|---|---|---|---|---|---|
| Position | Clicks | | Clicks | | Clicks | |
| 1 | A | 104.5 | C | 103.90 | A | 26.24 |
| 2 | C | 109.73 | B | 63.03 | B | 23.87 |
| 3 | B | 40.76 | A | 20.78 | C | 11.81 |

Total clicks for C=225.44 and revenue=90.176. The revenue increase from B almost equals the decrease from C. The new schedule returns total revenue $250.17.

However, if instead of increasing the budget, B increases 20% of his bid to $0.60. In this case, CPC for A is increased to $0.78. An optimal solution is shown in Table 10.

TABLE 10

Time share

| | 0.1673 | | 0.5598 | | 0.2729 | |
|---|---|---|---|---|---|---|
| Position | clicks | | clicks | | clicks | |
| 1 | A | 33.46 | C | 167.94 | C | 81.87 |
| 2 | C | 35.13 | A | 78.37 | B | 49.67 |
| 3 | B | 13.05 | B | 43.66 | A | 16.37 |

The change reduces the clicks for A from 151.52 to 128.2 as general second price auction usually does. However it also increases clicks for C from 249.98 to 284.94. With the budget factor optimization, the budget sufficient accounts get the benefit when other accounts further tightening the budget.

The example shows when budget is tight, adding budget can gain more clicks right away. Bidding over value with a tight budget may help others.

With search volume increases, staying at top positions all the time can be very expensive for advertisers. At the same time, the SERP spaces are valuable resources for search engines. Even from very small examples, one can see significant waste by keeping a predetermined ranking. In some embodiments, a better solution is provided using inventory optimization and using determined ranks. In some embodiments, the bidders will obtain the same or more clicks with same prices as serviced by the existing 2-factor generalized second price auction, however their ranking may vary during the serving period. When optimization is used, the search engine can better utilize the SERP to achieve maximize the revenue.

The foregoing example also shows the effects with bid changes. An inventory optimization algorithm of a search engine can have a further advantage of keeping bidders bidding on their own values.

Although embodiments of the invention are described primarily with regard to sponsored search, the invention is not so limited. Some embodiments of the invention include adding time-based advertiser budget as a factor in advertising or content prioritization, placement, ranking or ordering in non-sponsored search advertising or content presentation contexts, such as graphical or banner advertising. These include non-sponsored search contexts in which an auction method is used regarding such prioritization, placement, ranking or ordering.

The foregoing description is intended merely to be illustrative, and other embodiments are contemplated within the spirit of the invention.

What is claimed is:

1. A method comprising:
using one or more computers, in a sponsored search auction, obtaining advertiser bid amount information allowing determination of amounts that advertisers will pay per user click on advertisements served in association with advertiser bids, the advertiser bid amounts being associated with advertising campaigns;
using one or more computers, storing the advertiser bid information;
using one or more computers, obtaining click through rate information associated with at least some of the advertisements;
using one or more computers, storing the click through rate information;
using one or more computers, in association with each of at least some of the advertising campaigns, obtaining budget information associated with the advertising campaign, the budget information specifying a maximum advertiser spend over a period of time in association with at least a portion of the advertising campaign;
using one or more computers, storing the budget information;
using one or more computers, determining ranking of a set of advertisements to be served based at least on factors comprising the bid amount information, the click through rate information, and the budget information; and
using one or more computers, facilitating serving of the set of advertisements in accordance with the ranking.

2. The method of claim 1, comprising serving of the set of advertisements.

3. The method of claim 1, comprising determining auction pricing based at least in part on the budget information.

4. The method of claim 1, wherein the sponsored search auction is a second price auction, and comprising facilitating operating the auction.

5. The method of claim 1, wherein determining ranking comprises using advertisement inventory optimization.

6. The method of claim 1, wherein determining ranking comprises using linear programming.

7. The method of claim 1, wherein obtaining the budget information comprises obtaining the budget information specifying a maximum advertiser spend over a period of time in association with the advertising campaign.

8. The method of claim 1, wherein obtaining the budget information comprises obtaining the budget information specifying a maximum advertiser spend over a period of time in association with an advertiser account comprising the advertising campaign.

9. The method of claim 1, wherein obtaining the budget information comprises obtaining the budget information specifying a maximum advertiser spend over a period of time in association with a specified set of advertisements.

10. The method of claim 1, wherein obtaining the budget information comprises obtaining the budget information specifying a maximum advertiser spend over a period of time in association with one or more specified advertisement groups.

11. The method of claim 1, wherein the budget relating to a repeating period of time.

12. The method of claim 1, wherein the budget is a daily budget.

13. The method of claim 1, wherein the click through rate information comprises predicted, historical or estimated click through rate information.

14. The method of claim 1, comprising ranking advertisements based on factors including bid amounts associated with the advertisements, predicted click through rates associated with the advertisements, and the budget information, and wherein the budget information specifies budgets that include spend associated with user clicks on advertisements associated with the bid amounts.

15. A system comprising:
one or more server computers connected to the Internet; and
one or more databases connected to the one or more server computers;
wherein the one or more server computers are for:
in a sponsored search auction, obtaining advertiser bid amount information allowing determination of amounts that advertisers will pay per user click on advertisements served in association with advertiser bids, the advertiser bid amounts being associated with advertising campaigns;
storing the advertiser bid information in at least one of the one or more databases;
obtaining click through rate information associated with at least some of the advertisements;
storing the click through rate information in at least one of the one or more databases;
in association with each of at least some of the advertising campaigns, obtaining budget information associated with the advertising campaign, the budget information specifying a maximum advertiser spend over a period of time in association with at least a portion of the advertising campaign;
storing the budget information in at least one of the one or more databases;
determining ranking of a set of advertisements to be served based at least on factors comprising the bid amount information, the click through rate information, and the budget information; and
facilitating serving of the set of advertisements in accordance with the ranking.

16. The system of claim 15, wherein the one or more server computers are for serving the advertisements.

17. The system of claim 15, wherein the one or more servers are for advertisement inventory allocation and scheduling including a advertising associated with a plurality of advertising campaigns.

18. The system of claim 15, wherein the one or more server computers are for ranking advertisements based on factors including bid amounts associated with the advertisements, predicted click through rates associated with the advertisements, and the budget information, and wherein the budget information specifics budgets that include spend associated with user clicks on advertisements associated with the bid amounts.

19. A computer readable medium or media containing instructions for executing a method, the method comprising:
using one or more computers, in a sponsored search auction, obtaining advertiser bid amount information allowing determination of amounts that advertisers will pay per user click on advertisements served in association with advertiser bids, the advertiser bid amounts being associated with advertising campaigns;
using one or more computers, storing the advertiser bid information;
using one or more computers, obtaining click through rate information associated with at least some of the advertisements;
using one or more computers, storing the click through rate information;
using one or more computers, in association with each of at least some of the advertising campaigns, obtaining budget information associated with the advertising campaign, the budget information specifying a maximum advertiser spend over a period of time in association with at least a portion of the advertising campaign;
using one or more computers, storing the budget information;
determining ranking of a set of advertisements to be served based at least on factors comprising the bid amount information, the click through rate information, and the budget information, wherein determining ranking includes determining an order in which advertisements of the set of advertisements are to be presented on a Web page;
wherein the ranking is based at least in part on factors including bid amounts associated with the advertisements, predicted click through rates associated with the advertisements, and the budget information, and wherein the budget information specifies budgets that include spend associated with user clicks on advertisements associated with the bid amounts, and
wherein linear programming is used in the determining ranking; and
facilitating serving of the set of advertisements in accordance with the ranking.

20. The computer readable medium or media of claim 19, wherein the method comprises serving the set of advertisements in accordance with the ranking.
